(19) United States
(12) Patent Application Publication
(10) Pub. No.: US 2020/0256281 A1
(43) Pub. Date: Aug. 13, 2020

(54) High Dynamic Density Range Thermal Cycle Engine

(71) Applicant: Joshua M. Schmitt, San Antonio, TX (US)

(72) Inventor: Joshua M. Schmitt, San Antonio, TX (US)

(21) Appl. No.: 16/461,947

(22) PCT Filed: Nov. 8, 2017
(86) PCT No.: PCT/US2017/060722

§ 371 Date: May 17, 2019

Related U.S. Application Data
(60) Provisional application No. 62/424,494, filed on Nov. 20, 2016.

(51) Int. Cl. F02G 1/044; F02G 1/045; F02G 1/055

(52) U.S. Cl. CPC F02G 1/044; F02G 1/045; F02G 1/055; F02G 2244/50; F02G 2270/85; F02G 2254/30; F02G 2270/40

(57) ABSTRACT

An engine utilizing multiple closed loop heat exchangers. The engine makes use of a first exchanger dedicated to a given chamber of a piston assembly. This exchanger is configured to provide both heating and cooling to the chamber for changing the volume thereof in stroking the piston. The second exchanger is configured similarly to provide both heating and cooling to another chamber at the opposite side of the piston for correspondingly facilitating a change in its volume as the piston is stroked. This unique configuration allows for the working substance in the chambers, generally an operating CO₂ fluid, to effectively remain in a supercritical state for the substantial duration of the thermal cycle.

### BACKGROUND

Over the years, efforts have been undertaken to obtain work or power through an engine that is driven by different principles of thermodynamics. For example, techniques for generating electrical power from equipment relying on the “Stirling” or “Organic Rankine” cycle (ORC) have been developed. Unfortunately, these technologies have been generally ineffective and inefficient without the requirement of highly elevated temperatures. For example, lower heat sources, say below the boiling point of water, have been largely ineffective.

By way of example, ORC engine manufacturers often provide a system that allows for operation with input heat temperatures as low as 170° F. So, for example, a refrigerant that might more easily move from a liquid to a gas state may be utilized wherein turbine or turbine-like technology converts the pneumatic forces of the gas to generate productive work. However, a dramatically reduced output is generally also attained, thereby making the undertaking significantly less economical. In part, this is due to the properties of the working fluids used by ORC and the range and efficiency capabilities of the machinery extracting work from the working fluid.

Alternative technologies for converting low grade heat into usable work are also generally inefficient or unproductive as well. As used herein, the term “low grade heat” is heat that is below the boiling point of water at sea level. Regardless, most of these technologies are also based on the Organic Rankine thermodynamic cycle, which again involves converting a liquid to a gas and back again two phase changes per cycle. These are considered “thermal pneumatic heat engines”.

The ORC engines noted above convert a liquid with a low boiling temperature to its gas state and channels the gas or gas-and-liquid mixture through a turbine-like device to produce rotary motion. Apart from the inefficiencies noted above, such engines operate at a rotational speed of near 5,000 rpm or more. The gas mixture is then cooled back to a liquid state, changing phase again before reuse. Even setting aside inefficiencies, such speed and dramatic phase changes create significant noise, not unlike a jet engine.

Another technology that has been attempted is known as “thermal hydraulic heat engines”. This technology involves the use of heat applied to a liquid that may have a relatively high coefficient of expansion. As a practical matter, however, most liquids expand very little when heated and contract very little when cooled. Thus, in actual practice, such engines fail to attain successful commercialization due primarily to the difficulty of obtaining sufficient expansion, and sufficiently rapid expansion and contraction, in liquids. This limits the economic viability of such engines. Further, even when utilized, such engines are only practical for use in a narrow set of specific circumstances. This is because of the general inflexibility in terms of available modifications for differing uses. In fact, extensive trial and error is generally required even for the circumstances in which the engines may be effectively utilized. This is due, in part, to the inherent limitation involved with placing primary reliance on the expansion and contraction of a liquid by the introduction and removal of heat.

### SUMMARY

A method of obtaining work from an engine by governing the flow of a working substance, typically a supercritical fluid, to a chamber of changing volume. The method includes heating the working substance with a heat exchanger in hydraulic communication with the chamber to increase the volume of the chamber. The heat exchanger is also utilized to cool the working substance to decrease the volume of the chamber.

### BRIEF DESCRIPTION OF THE DRAWINGS

FIG. 1 is a top view depiction of an embodiment of a high dynamic density range thermal cycle engine to provide work.

FIG. 2A is a side view depiction of the thermal cycle engine of FIG. 1.

FIG. 2B is an opposite side view depiction of the thermal cycle engine of FIGS. 1 and 2.

FIG. 3 is a schematic representation of an engine layout for the thermal cycle engine of FIG. 1.

FIG. 4A is a schematic illustration of an embodiment of an opposing piston assembly of the engine of FIG. 1.

FIG. 4B is a chart depicting an embodiment of a thermal cycle providing a work output based on an expansion and compression profile for the piston assembly of FIG. 4A.

FIG. 5A is a perspective view of a portion of an embodiment of a tubesheet heat exchanger of the engine of FIG. 1.

FIG. 5B is a front view of a hexagonal configuration of the tubesheet heat exchanger of FIG. 5A.

FIGS. 6A-6E are schematic illustrations of the opposing piston assembly of FIG. 4A with movement sequence over time during operation.

FIG. 7 is a flow-chart summarizing an embodiment of employing a thermal cycle engine utilizing closed loop dedicated heat exchangers.

### DETAILED DESCRIPTION

In the following description, numerous details are set forth to provide an understanding of the present disclosure. However, it will be understood by those skilled in the art that the embodiments described may be practiced without these particular details. Further, numerous variations or modifications may be employed which remain contemplated by the embodiments as specifically described.

Embodiments detailed herein are directed at a unique manner of controlling the expansion and contraction of a working substance in the form of a supercritical fluid within a closed loop or container. Specifically, this expansion and contraction of the working substance is used to move a piston in order to ultimately generate productive work. When generating power with a motor attached to a generator, the engine may display a “low” rotational speed of less than about 50 rpm. Further, embodiments detailed herein may avoid changes in phase, and so are inherently more thermodynamically efficient, and with the appropriate operating fluid may operate effectively using input temperatures below 200° F. In fact, they can easily be tuned to operate with minor reductions in efficiency with input heat below 150° F. It also operates almost silently. However, in other embodiments, alternative temperature ranges and different rotational speeds may be utilized along with an allowance for some degree of phase change for the fluid. So long as both heating and cooling of a chamber containing the fluid is governed by the same heat exchanger, appreciable benefit may be realized.

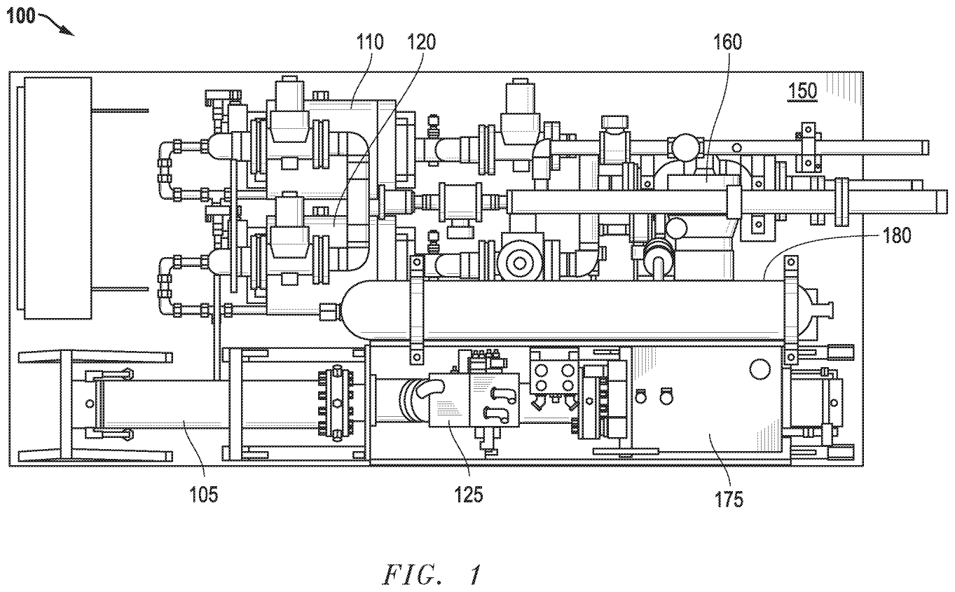

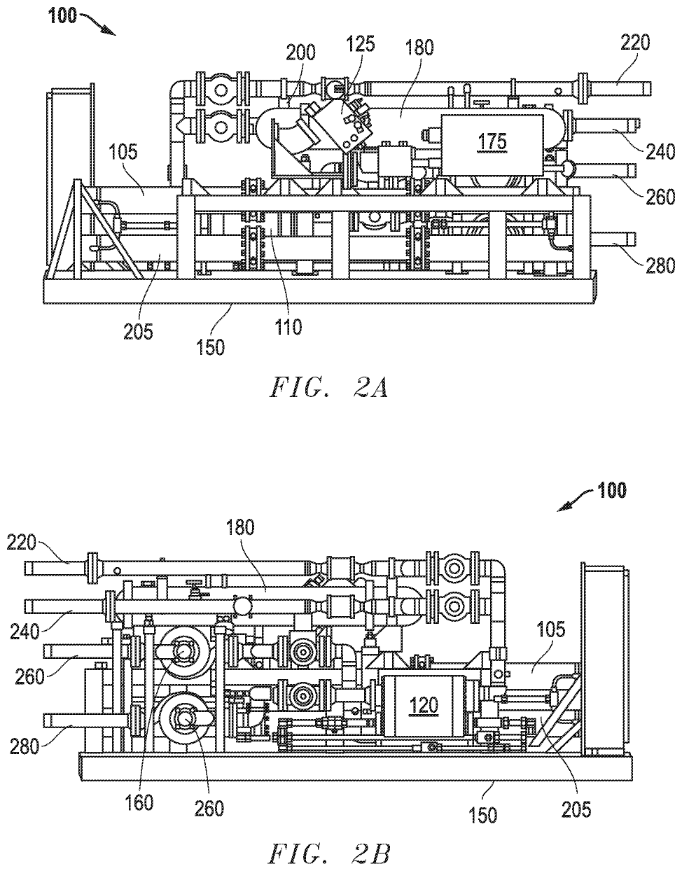

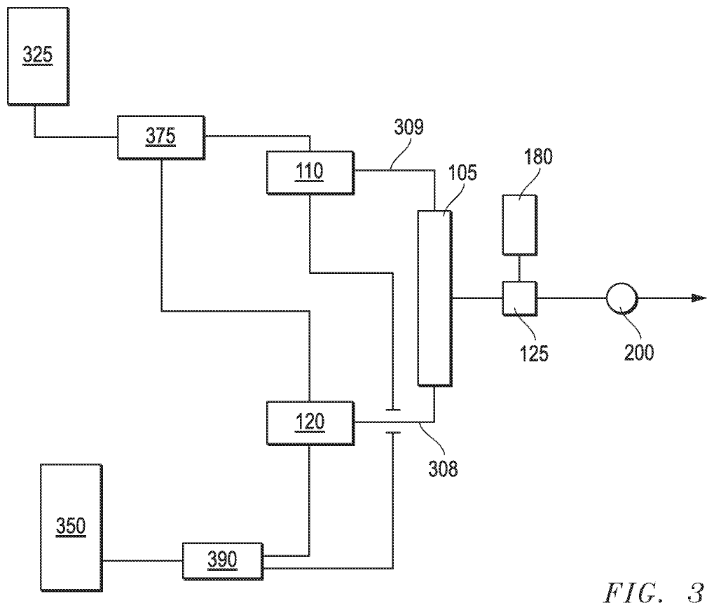

Referring now to FIG. 1 with added reference to FIG. 3, a top view of an embodiment of a thermal cycle engine 100 is depicted. The engine 100 is provided on a skid frame 150 where a host of engine components are securely held in modular fashion. As alluded to above, dedicated heat exchangers 110, 120 are provided that are in hydraulic communication with only one side of a piston assembly 105 (also see the piston 205 of FIG. 2). That is, as illustrated in the schematic of FIG. 3, a closed reservoir of fluid may be circulated between a heat exchanger 110 and a chamber at one side of a piston assembly 105 over a dedicated line 309. Similarly, another closed reservoir of fluid may be circulated between the other heat exchanger 120 and a chamber at the opposite side of the piston assembly 105 over another dedicated line 308.

Other engine components are apparent with reference to the top view of FIG. 1. For example, note a hydraulic accumulator 180 which may work in synchronization with valving at a manifold 125 to periodically provide added force to piston strokes. A hydraulic reservoir 175 is also apparent. With added reference to FIG. 3, this reservoir 175 may serve as (or supply) a hot 390 or cold 375 fluid tank. Specifically, a pump 160 may be used to circulate hot water from a tank 390 and associated heat source 350 to heat the appropriate heat exchanger (110 or 120) at the appropriate time depending on the position of the stroking piston within the piston assembly 105. As noted, in one embodiment, this water may be between about 150° F. and about 200° F.

By the same token another pump (not visible in FIG. 1) may be used to circulate cold water from the cold fluid tank 375 and cooling source 325 to the appropriate heat exchanger (110 or 120) at the appropriate time. In one embodiment, the cold water is water that is kept at about room temperature, perhaps from an adjacent body of water. That is, there is not necessarily a requirement that undue energy be spent actively cooling the water. However, in other embodiments, an evaporative cooler may be utilized.

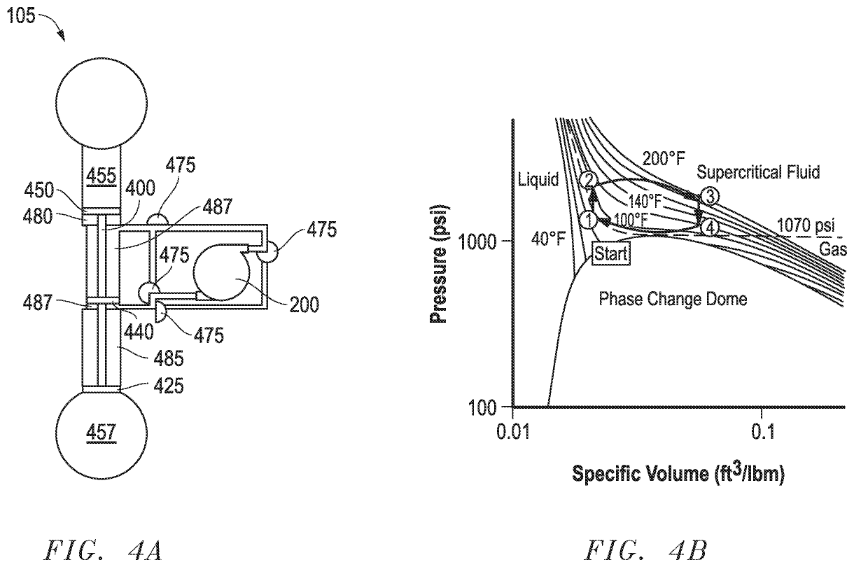

With specific reference to FIG. 3, with brief added reference to FIG. 4A, it is worth noting that the timing for heating the first heat exchanger 105 will coincide with the timing for cooling the second heat exchanger 120 and vice versa. Thus, as pressure within the piston assembly 105 is increased at a first chamber 455 it is simultaneously decreased within an opposite second chamber 457, thereby enhancing the stroking of the piston 400 (e.g. in a downward direction as depicted in FIG. 4A). Of course, at the end of the stroke, the process is reversed with the second heat exchanger 120 being heated, the first 110 being cooled, the chambers 455, 457 reversed in differential pressure with the second 457 being higher and the piston 400 stroked in the opposite direction (e.g. upward as illustrated in FIG. 4A).

Returning to FIG. 3, recall that each heat exchanger 110, 120 is equipped with its own dedicated line 307, 308 running to the piston assembly 105. Specifically, with added reference to FIG. 4A, the dedicated line 307 running from the first heat exchanger 110 is in fluid communication with the first chamber 455 of the assembly 105. Alternatively, the dedicated line 308 from the second heat exchanger 120 is in fluid communication with the second chamber 457. In this manner two separate closed loop hydraulic systems are provided with the piston 400 of FIG. 4A cyclically stroking in the direction of reduced volume and pressure and away from increased volume and pressure on a continual basis. However, these hydraulic loops, between chamber and heat exchanger (e.g. 455/110 and 457/120), remain closed. That is, the fluid circulating to the heat exchangers 110, 120 from hot 375 or cold 390 water tanks is not mixed with the noted closed loop hydraulic systems. Instead, as heated water enters a given exchanger, an appropriately selected operating fluid rapidly expands outward therefrom and as cooled water enters, the operating fluid rapidly contracts back into the exchanger. Also note that this temperature regulating fluid may be water or other fluid of a different type than that within the closed loop systems. By way of contrast, the closed loop systems may utilize supercritical carbon dioxide (CO₂) as the operating fluid due to unique expansive properties as detailed below.

The described thermodynamic cycling may be uniquely efficient, effectively utilizing input temperatures below 200° F. Indeed, the cycling may be tuned to operate at below 150° F. without substantial reduction in efficiency. As a result, the engine 100 may flexibly take advantage of a host of available heat sources. For example, useful work may ultimately be obtained from low grade heat sources such as geothermal heat, solar heat or the waste heat from other unrelated system operations. This allows for an effective and economical utilization of a vast array of heat sources previously considered to be too cool and of no practical economic value.

As detailed further below, where the operating fluid in the closed loops is CO₂, keeping it in a supercritical or superheated gas state may be less of a challenge. As a result, the application of heating increases the volume and achieves dramatic expansion in order to increase pressure and drive the piston movement as discussed above. Further, the application of cooling the operating fluid prompts it to take on a smaller volume, thus further encouraging piston movement where applied to an opposite chamber from that of the heating. As detailed further below, this thermal cycle is particularly efficient where the operating fluid is able to avoid phase change for the substantial duration of the cycle.

Referring now to FIG. 2A, a side view depiction of the thermal cycle engine 100 of FIG. 1 is shown. In this view some additional engine components are visible. For example, the frame accommodates the initially depicted piston assembly 105 as well as another piston assembly 205 to effectively double the output as discussed further below. So, for example, a heat exchanger 110 may govern a closed loop that includes the chamber 455 of one assembly 105 as well as another chamber of another assembly 205 (again see FIG. 4A). Along these lines, a host of additional piston assemblies may be added to the engine if so desired. Regardless, in the embodiment shown, the piston assemblies 105, 205 may cycle in synchronicity, perhaps with the added aid of valving also discussed further below.

In addition to the hydraulic reservoir 175, accumulator 180 and manifold 125 as described above, a hydraulic motor 200 is also apparent in FIG. 2A. Specifically, work from the thermal cycle engine 100 is ultimately transferred through to a motor 200 where it may ultimately be employed to generate and transmit power.

Continuing with reference to FIG. 2A, various hydraulic lines are also shown for circulating hot and cold water to and from the heat exchangers 110 (and 120 of FIG. 1). More specifically, cold water supply 280 and return 220 lines are provided as well as hot water supply 260 and return 240 lines. Thus, the appropriate temperature effectuating water type may be circulated to and from the appropriate heat exchanger 110, 120 at the appropriate time as discussed above (see FIG. 1).

Referring now to FIG. 2B, the engine 100 is shown from the opposite side as compared to FIG. 2A. In this view, the same water circulation lines 220, 240, 260, 280 are apparent as well as the other heat exchanger 120. The piston assemblies 105, 205 are also apparent along with the accumulator 180. Additionally, the hot pump 160 described above that is used to circulate hot water to the appropriate heat exchanger (110 or 120) at the appropriate time is shown as well as a cold pump 260 that is used to circulate cold water to the appropriate heat exchanger (110 or 120) at the appropriate time.

Referring now to FIG. 3, a schematic representation of an engine layout for the thermal cycle engine 100 of FIGS. 1, 2A and 2B is shown. As indicated above, this engine 100 ultimately facilitates work output from a motor 200 in a uniquely efficient manner. This includes utilizing a unique system of heat exchangers 110, 120 where each exchanger 110, 120 is independently dedicated to one side of the pump assembly 105. This means that each exchanger 110, 120 defines and governs a closed hydraulic loop in which both the high and low temperature cycles are managed through the same exchanger 110, 120 for the given side of the assembly 105. Thus, a heated input is applied alternatingly to each exchanger 110, 120 in sequence (e.g. from heat source 350 and hot water tank 390). At the same time, a cold input is applied alternatingly to the opposite exchanger 110, 120, and also in sequence (e.g. from the cold source 325 and cold water tank 375).

Continuing with reference to FIG. 3, the reciprocating piston 400 within the assembly 105 circulates hydraulic oil through the manifold 125 which houses a variety of check valves timed to ensure proper reciprocation and timing of the piston 400 (see FIG. 4A). Indeed, the manifold 125 is also in hydraulic communication with the indicated accumulator 180 which may periodically charge and supply a flow of working fluid to a when the piston 400 is not moving or supply added pressure back through the manifold 125 to facilitate piston reciprocation (e.g. at the end of piston strokes). Further, even the motor 200 itself may play a role in the timing of piston reciprocation. For example, the motor 200 may be configured to operate at a substantially constant fixed speed, perhaps below about 50 rpm. Apart from being efficient and near silent, this type of constant fixed displacement may be hydraulically linked back through the manifold 125 to further help regulate the rate of piston reciprocation. Ultimately, a very controlled and reliably synchronized manner of reciprocation and output may be attained.

Referring now to FIG. 4A, a schematic illustration of an embodiment of an opposing piston assembly 105 of the engine 100 of FIG. 1 is shown. The illustration reveals the piston 400 within the assembly 105 that is reciprocated between chambers 455, 457 which are themselves a part of separate closed loop systems circulating operating fluid. In the embodiment shown, the operating fluid is CO₂, generally in a supercritical state as discussed further below. Additionally, as the piston 400 is reciprocated, intermediate chambers 487, defined by an intermediate head 440 are used to circulate an incompressible working fluid such as hydraulic oil toward a series of valves 475 and ultimately a motor 200 as discussed above. The motor 200 may be a hydraulic motor or even a crankshaft and the valves 475 may be modularly incorporated into the manifold 125 as described above (see FIG. 3). In this way, the circulating hydraulic oil may provide work that is translatable through a motor 200. The motor may then be utilized for the production of electrical power through a generator. However, a pump, motive power or compressor may also be driven by the motor or the hydraulic power may even be used directly without any connection to a motor.

In the embodiment shown, the intermediate chambers 487 are bordered by compartments 480, 485. These may be air filled compartments 480, 485 which serve as a sealing buffer between the working fluid chambers 455, 457 and the hydraulic oil of the intermediate chambers 487. The timing of valve 475 opening and closing as well as the rpm of the motor 200 also help synchronize this circulation and the piston reciprocation. For example, valves 475 may momentarily close each time the piston nears the end of each stroke so as to drive up pressure and help initiate stroking in the opposite direction. Such timing may be regulated by an electronic controller.

Referring now to FIG. 4B, a chart depicting an embodiment of a thermal cycle providing a work output based on an expansion and compression profile for the piston assembly of FIG. 4A is shown. This type of chart may be referred to as a P-v diagram. Specifically, the chart reveals a chamber (e.g. 455) being pressurized by way of heating. This can be seen in the move from (1) to (2) with the pressure moving up from about 1,200 psi to perhaps over 1,500 psi as the temperature rises from about 100° F. to a little over 150° F. Thus, the pressure in the chamber 455 acts upon the piston head 450 and effects a volume increase with the piston 400 moving in a downward direction. Note the move from (2) to (3) in FIG. 4B reflecting the volume increase. Notice that the temperature also begins to slightly drop at this point. However, a much more dramatic drop, from (3) to (4) is effectuated by the tailored introduction of cold through the heat exchange technique described above. Specifically, at (4) the temperature has moved from a little under 150° F. at (3) to below about 100° F. Note that this is still above 88° F. (which ensures that the CO₂ remains supercritical). Thus, at this point movement of the piston toward this chamber 455 would be encouraged, particularly in light of the other chamber 457 being heated according to the techniques described above. Indeed, notice the corresponding volume reduction in this chamber 455 with the move from (4) back over to (1).

In the embodiment of FIG. 4B, with added reference to FIG. 4A, the pressure and temperature combination within the chamber 455 are maintained at levels where the operating fluid, in this case CO₂ is kept in a supercritical state. This is not necessarily required for effective operation. However, greater efficiencies will be attained where the operating fluid is kept in a supercritical or superheated gas state throughout the substantial duration of the thermal cycle. More specifically, avoiding undue phase change of the operating fluid into and out of a liquid or “dense” state may enhance efficiency. Further, with the techniques and equipment setup detailed here, operating substantially outside of the “phase change dome” throughout is readily attainable.

It is worth noting that for alternative operating fluids, a host of different pressures and temperature ranges may be employed to maintain the fluid in a supercritical or superheated gas state for the substantial duration of the cycle. In the embodiment shown, CO₂ is utilized given that it allows for relatively low heat and manageable pressures to rapidly and readily display these characteristics. However, other fluid types may be modeled and discretized. Additionally, a variety of piston dimensions and other variables evaluated for alternative tolerances that may be utilized in running a thermal cycle according to the techniques described here.

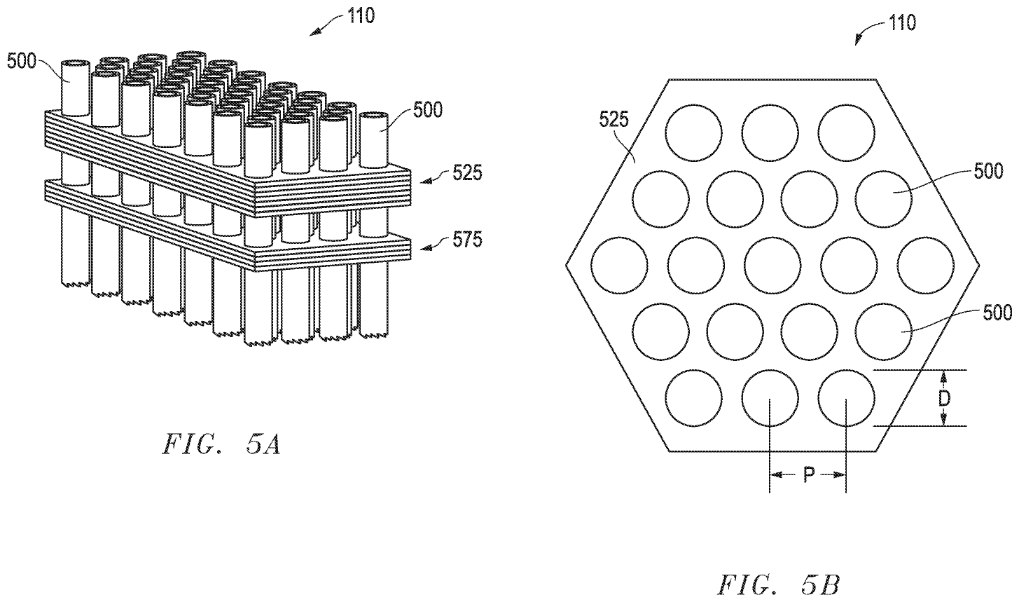

Referring now to FIG. 5A, a perspective view of an embodiment of a tubesheet heat exchanger 110 of the engine 100 of FIG. 1 is shown. The exchanger 110 is of a robust configuration that is tailored to handle the rapid heating and rapid cooling stressors that are placed on it during thermal cycles as described above and further below. Thus, the portion of the exchanger 110 depicted may be housed in a thick or double walled shell capable of withstanding the stress of continual and rapid heating and cooling. In this regard, stainless steel or other robust material choices may be employed.

Since the heat exchanger is determinative of the amount of energy addition and rejection over the course of thermal cycling, the sizing of the entire engine 100 of FIG. 1 begins with the sizing of the exchangers 110, 120. In the embodiment of FIG. 5A, a tubesheet exchanger 110 includes a plurality of micro-tubes 500 held in position by alignment plates 525, 575. In contrast to a conventional exchanger, the depicted tubesheet exchanger 110 does not have the operating fluid pass through. Instead, the exchanger acts as a reservoir which holds the operating fluid. Thus, upon application of heat as described above, the fluid rapidly expands, largely leaving the exchanger 110, or upon application of cooling, the fluid rapidly contracts back into the smaller volume of exchanger 110 (e.g. as described above). Not only does the fluid type affect the rate of this process but so too does the tubular nature of the exchanger 110 which effectively dramatically increases the surface area of the exchanger 110 acting upon the operating fluid.

With particular reference to FIG. 5B, a front view of a hexagonal configuration of the tubesheet heat exchanger of FIG. 5A is shown in hexagonal form. The spacing of the tubes 500 may be defined by a predetermined pitch (P) and diameter (D) that are set based on a variety of other variables such as thickness of the tube walls. So, for example, this particular value may be of significance given the durable nature of the exchanger 110 in light of the repeated and rapid temperature variations to which it may be exposed.

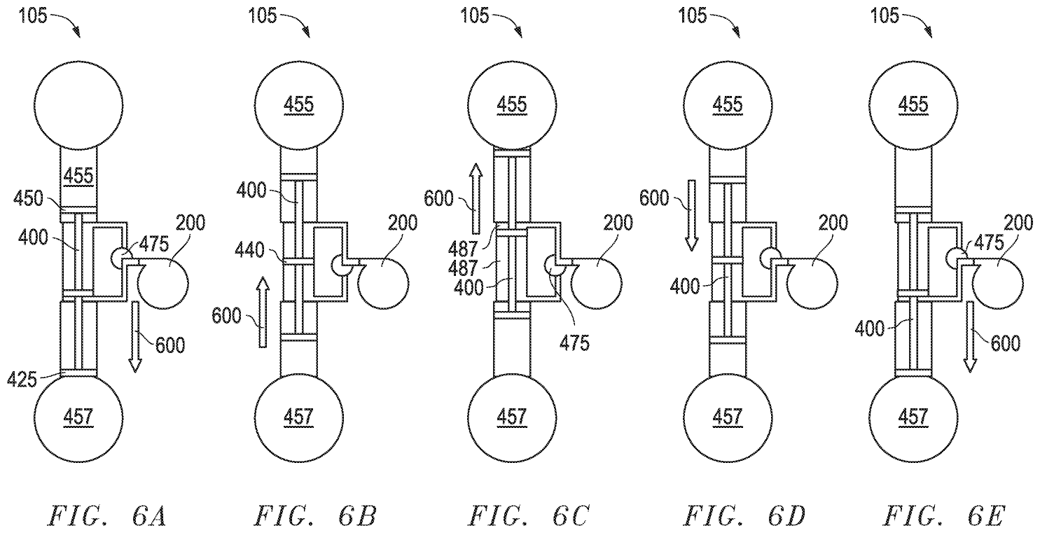

Referring now to FIGS. 6A-6E, schematic illustrations of the opposing piston assembly 105 of FIG. 4A are shown with a movement sequence over time during operation. Indeed, FIG. 6A resembles FIG. 4A with the operating fluid, supercritical CO₂, within the first chamber 455 having attained sufficient pressure to drive the piston 400 a full stroke in the direction shown (see 600). Ultimately, this means that work may be directed toward a motor 200. For the embodiments herein, added timing and guidance may be provided through valving (e.g. see valve 475).

With an initial stroke completed, the second chamber 457 may be heated at the same time that the first chamber 455 is cooled (See FIG. 6B). As a result, the piston 400 may be held in place such that it builds more pressure or allowed to reverse course, stroking in the opposite direction (see arrow 600). Eventually, the piston 400 will reach the end of this stroke as well (see FIG. 6C). Notice that throughout the described stroking, the intermediate chambers 487 continue to circulate hydraulic oil with the motor 200 to effectively allow work to be obtained from the system.

As shown in FIG. 6D, with the piston 400 completing its stroke toward the first chamber 455, this chamber may once again be heated until a desired pressure is built and the piston driven back in the direction of the second chamber 457, which itself is cooled to further facilitate the process (see arrow 600). Eventually, the piston 400 will again reach the end of this stroke as shown in FIG. 6E, where it is returned to the position it occupied in FIG. 6A.

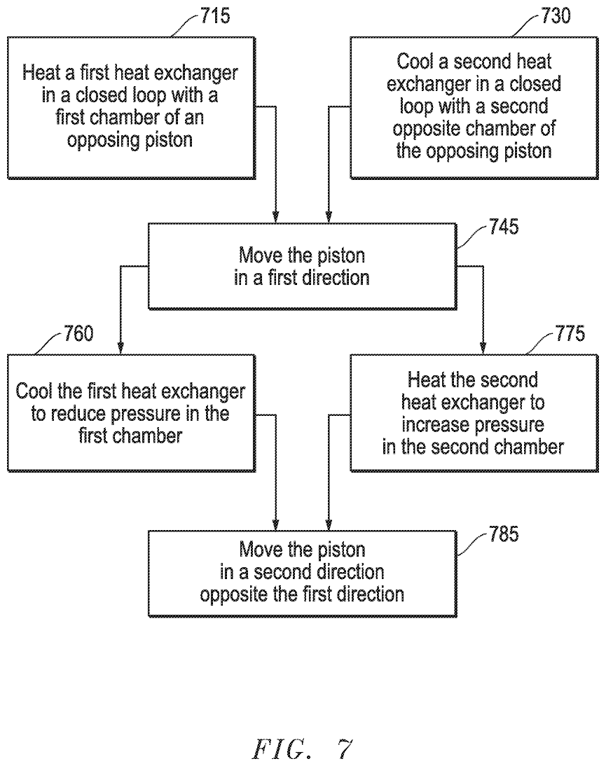

Referring now to FIG. 7, a flow-chart is shown which summarizes an embodiment of employing a thermal cycle engine utilizing closed loop dedicate heat exchangers. Namely, as indicated at 715 one heat exchanger in a closed loop with a chamber of a piston assembly is heated. Simultaneously, a second heat exchanger in a closed loop with an opposite chamber of the assembly is cooled (see 730). In this manner, a piston of the assembly is moved in a first direction as noted at 745. The process is then reversed with the first heat exchanger cooled as indicated at 760 and the second heat exchanger heated as indicated at 775. Thus, the piston is now moved in the opposite direction (see 785).

The preceding description has been presented with reference to presently preferred embodiments. Persons skilled in the art and technology to which these embodiments pertain will appreciate that alterations and changes in the described structures and methods of operation may be practiced without meaningfully departing from the principle and scope of these embodiments. Furthermore, the foregoing description should not be read as pertaining only to the precise structures described and shown in the accompanying drawings, but rather should be read as consistent with and as support for the following claims, which are to have their fullest and fairest scope.

I claim:

1. A thermal cycle engine comprising:
a first heat exchanger in a closed hydraulic loop with a first chamber for regulating a volume thereof; and
a second heat exchanger in a closed hydraulic loop with a second chamber for regulating a volume thereof, the volume of each chamber dependent upon the volume of the other.

2. The thermal cycle engine of claim 1 wherein the heat exchangers are of a tubesheet configuration to enhance surface interaction with a working substance occupying the closed loop.

3. The thermal cycle engine of claim 1 further comprising an opposing piston assembly, the assembly comprising a piston with a first head defining the first chamber and a second head defining the second chamber.

4. The thermal cycle engine of claim 3 wherein the piston further comprises at least one intermediate chamber between the heads to pressurize and circulate an incompressible working fluid to a working output as the volumes of the first and second chambers change.

5. The thermal cycle engine of claim 3 further comprising a motor hydraulically driven by the piston assembly.

6. The thermal cycle engine of claim 5 further comprising one of a pump, a compressor, an electrical power generator, and a motive power device driven by the motor.

7. The thermal cycle engine of claim 5 further comprising a manifold hydraulically linked between the motor and the piston assembly to coordinate timing there between.

8. The thermal cycle engine of claim 7 further comprising an accumulator hydraulically coupled to the manifold to provide a flow of working fluid to a motor when the piston is not moving and supply pressure to supplementally enhance stroking of the piston.

9. The thermal cycle engine of claim 3 wherein the opposing piston assembly is a first opposing piston assembly, the engine further comprising a second piston assembly with another chamber in the closed loop of the one of the first and second heat exchangers.

10. The thermal cycle engine of claim 1 further comprising a hot fluid tank for supplying heat to one of the first and second exchangers to increase the volume of one of the first and second chambers.

11. The thermal cycle engine of claim 10 wherein fluid of the tank is water at between about 150° F. and 200° F., heat therefore available from one of waste heat, geothermal heat and solar heat.

12. The thermal cycle engine of claim 1 further comprising a cold fluid tank for cooling one of the first and second exchangers to decrease the volume of one of the first and second chambers.

13. The thermal cycle engine of claim 12 wherein fluid of the tank is one of room temperature water and evaporatively cooled water.

14. A method of obtaining work from an engine, the method comprising:
heating a first heat exchanger in a closed loop with a first chamber to increase a volume of the first chamber; and
cooling a second heat exchanger in a closed loop with a second chamber to decrease a volume of the second chamber, the cooling occurring during the heating with the volume of each chamber dependent on the volume of the other.

15. The method of claim 14 further comprising moving a piston within a piston assembly defining the chambers away from the first chamber and toward the second chamber during the heating and the cooling.

16. The method of claim 15 further comprising:
cooling the first heat exchanger to reduce pressure in the first chamber;
heating the second heat exchanger to increase pressure in the second chamber during the cooling of the first heat exchanger; and
moving the piston toward the first chamber and away from the second chamber during the cooling of the first chamber and the heating of the second chamber.

17. The method of claim 15 further comprising employing the moving of the piston to power a motor.

18. The method of claim 14 wherein the volumes of the chambers are occupied by a supercritical fluid for the substantial duration of each of the heating and the cooling.

19. A method of obtaining power from an engine, the method comprising:
reciprocating at least one piston of the engine between first and second chambers, the chambers containing a thermodynamically regulated working substance therein;
heating the thermodynamically regulated working substance in the first chamber for moving the piston away from the first chamber and toward the second chamber;
cooling the thermodynamically regulated working substance in the second chamber during the heating in the first chamber to encourage the moving of the piston away from the first chamber; and
maintaining the thermodynamically regulated working substance as one of a supercritical fluid and a superheated gas within each chamber for a substantial duration of the heating and the cooling.

20. The method of claim 19 further comprising employing one of an accumulator and a manifold to provide a flow of working fluid to a motor when the piston is not moving and supply pressure to supplementally enhance stroking of the piston.
